(19) United States
(12) Patent Application Publication
(10) Pub. No.: US 2023/0256376 A1
(43) Pub. Date: Aug. 17, 2023

(54) DEVICE AND METHOD FOR RAPIDLY PREPARING CARBON FROM STRAWS AND RECYCLING AND TREATING FLUE GAS AND SMOKE DUST

(71) Applicant: Xiaoguang WANG, Taiyuan (CN)

(72) Inventor: Xiaoguang WANG, Taiyuan (CN)

(21) Appl. No.: 18/138,754

(22) Filed: Apr. 25, 2023

Related U.S. Application Data
(63) Continuation of application No. PCT/CN2022/109408, filed on Aug. 1, 2022.

(30) Foreign Application Priority Data
Jun. 25, 2021 (CN) 202110711054.9
Jun. 20, 2022 (CN) 202210697132.9

(51) Int. Cl. B01D 47/06; C10B 33/02; C10B 53/02

(52) U.S. Cl. CPC B01D 47/06; C10B 33/02; C10B 53/02

(57) ABSTRACT

A device and a method for rapidly preparing carbon from straws and recycling and treating flue gas and smoke dust are provided. The device includes a pyrolysis and carbonization chamber and a collection and separation chamber which are communicated with each other through a flue gas inlet. The collection and separation chamber includes a separation area in which a sprayer is disposed. The method includes: introducing straws that are ignited outside into the pyrolysis and carbonization chamber; introducing flue gas produced by the pyrolysis and carbonization chamber in running into the collection and separation chamber via the flue gas inlet, and at least separately treating the flue gas in the separation area in the collection and separation chamber; and introducing the flue gas into the separation area, and converting main component-biomass energy in the flue gas into straw vinegar using the sprayer in the separation area.

### CROSS REFERENCE TO THE RELATED APPLICATIONS

This application is the continuation application of International Application No. PCT/CN2022/109408, filed on Aug. 1, 2022, which is based upon and claims priority to Chinese Patent Applications No. 202110711054.9, filed on Jun. 25, 2021, and No. 202210697132.9, filed on Jun. 20, 2022, the entire contents of which are incorporated herein by reference.

### TECHNICAL FIELD

The present application belongs to the technical field of pyrolysis and carbonization of crop straws, specifically to a device and method for rapidly preparing carbon from straws and recycling and treating flue gas and smoke dust.

### BACKGROUND

Pyrolysis and carbonization of crop straws play an important role in the comprehensive utilization of the straws. Carbonization methods and equipment are becoming more mature in a process of technological progress, but there are still some defects, such as patent No. ZL 201110042313.X and European patent No. 2540803, entitled “Method and Device for Preparing Carbon from Crop Straws”. The device has a novel carbon preparation method and high carbonization efficiency, and mainly aims to recycle biomass carbon. However, there are the following defects:

1. Gaseous straw biomass produced by an original patented device in a pyrolysis process of carbon preparation is directly discharged into the atmosphere, resulting in a waste of resources.

2. According to the original patented device, under the condition of a certain feeding amount, the way to control the degree of pyrolysis of a material is the perception of an operator, which is achieved by turning a fire grate, so that the stability of a pyrolyzed material is difficult to control.

A settling chamber provided in the original patented device only makes part of suspended particles in the flue gas settle down and clears away the suspended particles through a longitudinal partition plate, and a large amount of biomass energy flue gas generated in the pyrolysis process of carbon preparation is directly discharged with a large number of suspended particles. Meanwhile, a large amount of water for cooling, fire extinguishing and dust falling will be required by the carbonized straw in a process of returning the straw carbon to the field or packaging the carbonized straw for reuse, so the device is difficult to use in water-deficient areas.

### SUMMARY

For the defects or shortcomings in the above related art, the technical problem to be solved in the present application is to provide a device and method for rapidly preparing carbon from straws and recycling and treating flue gas and smoke dust.

In order to resolve the above technical problem, the present application is realized through the following technical solutions.

In one aspect, the present application provides a device for rapidly preparing carbon from straws and recycling and treating flue gas and smoke dust, including a pyrolysis and carbonization chamber, and a collection and separation chamber;
the pyrolysis and carbonization chamber and the collection and separation chamber are communicated with each other through a flue gas inlet;
the collection and separation chamber includes a separation area in which a sprayer I is further disposed; and
flue gas enters the separation area through the flue gas inlet and is then discharged.

Optionally, the collection and separation chamber further includes a dust falling area which is communicated with the separation area; and after entering the dust falling area of the collection and separation chamber through the flue gas inlet, the flue gas enters the separation area and is then discharged.

Optionally, a water pump is arranged on the collection and separation chamber, and an outlet of the water pump is connected to the sprayer I respectively through a pipeline.

Optionally, the separation area includes a partition plate I and a partition plate II which are disposed at upper and lower positions; the flue gas enters the separation area from above the partition plate II; and the flue gas enters an exhaust funnel from below the partition plate I.

Optionally, a collection box is further arranged below the separation area.

Optionally, the collection box is further communicated with the sprayer I; and/or, a water pump is further connected between the collection box and the sprayer I.

Optionally, an upper part of the collection box is provided with a collected liquid outlet, and a bottom of the collection box is provided with a sewage draining exit.

Optionally, a bottom of the dust falling area is provided with a cleaning door.

Optionally, at least one partition plate III, at least one partition plate IV, or at least one partition plate III and one partition plate IV which are disposed on the left and right in a spacing manner are arranged in the dust falling area for allowing the flue gas to pass. The flue gas collection efficiency is improved; impurities in the flue gas are reduced; and the purity of straw vinegar is increased.

Optionally, a thermal insulation material is arranged between the pyrolysis and carbonization chamber and the collection and separation chamber.

Optionally, a conveying device used for conveying a material is mounted in the pyrolysis and carbonization chamber.

The conveying device includes a parallel conveying device, and the parallel conveying device adopts a parallel chain scraper conveyor.

Optionally, a material inlet of the pyrolysis and carbonization chamber is further communicated with a feeding device, and/or, a material outlet of the pyrolysis and carbonization chamber is further communicated with a discharging device.

Optionally, the feeding device adopts a chain scraper conveyor; and/or, the discharging device adopts a screw conveyor I; and an outlet of the screw conveyor I is connected to a discharging barrel.

Optionally, the device further includes a discharging barrel, which is arranged at an outlet of the discharging device; and a screw conveyor II is further mounted in the discharging barrel.

Optionally, a sprayer II is further mounted in the discharging barrel, and/or, the sprayer II is further connected to a collection box.

Optionally, the pyrolysis and carbonization chamber is integrally connected; and/or, the pyrolysis and carbonization chamber is further provided with an oxygen supply opening and an oxygen control valve.

In another aspect, the present application further provides a method for rapidly preparing carbon from straws and recycling and treating flue gas and smoke dust, the method including:
introducing straws that are ignited outside into a pyrolysis and carbonization chamber;
introducing flue gas produced by the pyrolysis and carbonization chamber in running into a collection and separation chamber via a flue gas inlet, and at least separately treating the flue gas in a separation area in the collection and separation chamber; and
introducing the flue gas into the separation area, and converting main component-biomass energy in the flue gas into straw vinegar using a sprayer I in the separation area.

Optionally, the method further includes: recycling the straw vinegar, wherein the recycled straw vinegar falls off to be collected, and the collected straw vinegar enters a spraying circulating system; and finally, the flue gas enters a flue and is discharged.

Optionally, the method further includes: before introducing the flue gas into the separation area, introducing the flue gas into a dust falling area of the collection and separation chamber, introducing the flue gas produced by the pyrolysis and carbonization chamber in running into the collection and separation chamber via the flue gas inlet, and at least separately treating the flue gas in the dust falling area and the separation area in the collection and separation chamber.

Compared with the prior art, the present application has the following technical effects:

According to the present application, the separation area is used to recycle, through the sprayer I, gaseous biomass energy produced during the pyrolysis, and biomass energy conversion liquid is used to replace water; the gaseous biomass energy is continuously recycled and converted, and the main component-biomass energy in the flue gas is converted into the straw vinegar for recycling, so that the utilization rate of biomass energy of straws of the original device is increased by 30-33% to 50%; and meanwhile, the biomass energy conversion liquid replaces water to make suspended particles produced during the pyrolysis and carbonization settle down. Main components of the straw biomass are cellulose and hemicellulose. Cellulose and hemicellulose are also main components of biomass energy in pyrolysis gas, which are discharged from the original device and not reused.

In the present application, the collection and separation chamber is provided with the separation area, and the kinetic energy of the water pump is used to create the functions of sealing, drafting, condensation and separation.

At initial work, a spraying system in the present application has a small amount of water for circulation. The recycled straw vinegar is mixed into and participates in the spraying circulating system, and is gradually transitioned to the self-circulation of straw vinegar spraying. The biomass energy conversion liquid is used to replace water to make the suspended particles produced during the pyrolysis and carbonization settle down, which ensures the continuous running of the collection and separation chamber; and in addition, the conversion liquid is used to replace the water to perform cooling, fire extinguishing and dust falling on the carbonized material. The working environment is improved; a load of carrying a water source on the mobile device is reduced; and all-weather running of the equipment is guaranteed.

In the present application, two chain scraper conveyors are used to connect material feeding with pyrolysis, and a relationship between a feeding amount and a pyrolysis time is transformed into a relationship between mechanical transmission rates, so that it is easier and more reliable to control the pyrolysis degree. In addition, the two independent pyrolysis and carbonization tanks in the original device are changed into one chamber body that is divided into upper and lower parts by the chain scraper conveyor, and the two parts are closely connected to each other and have different functions. The thermal energy utilization efficiency of the present application is improved, thereby laying a foundation for the standard production of different types of straw carbon. For example, due to a controllable degree of pyrolysis, if the main purpose of straw carbon production is to return “carbon” to fields, and to pursue “carbon neutralization”, a deep carbonization process that prolongs the carbonization time is adopted. On the contrary, if the main purpose is to kill insect eggs and pathogenic bacteria, and to return more original organic matters to fields, a light carbonization process with short carbonization time (only several minutes) is adopted.

The design of the present application is reasonable, and the device becomes a new method between a straw returning method and a straw biomass carbon returning method, and has good practical application value.

### BRIEF DESCRIPTION OF THE DRAWINGS

Other features, objectives, and advantages of the present application will become more apparent by reading the detailed descriptions made to the non-limiting embodiments with reference to the following drawings:

FIG. 1 is a schematic diagram of a technological process of a device for rapidly preparing carbon from straws and recycling and treating flue gas and smoke dust according to an embodiment of the present application.

FIG. 2 is a schematic diagram of a left side surface of a device for rapidly preparing carbon from straws and recycling and treating flue gas and smoke dust according to an embodiment of the present application.

FIG. 3 is a schematic diagram of a right side surface of a device for rapidly preparing carbon from straws and recycling and treating flue gas and smoke dust according to an embodiment of the present application.

FIG. 4 is a schematic diagram of a rear side surface of a device for rapidly preparing carbon from straws and recycling and treating flue gas and smoke dust according to an embodiment of the present application.

FIG. 5 is a schematic diagram of the section A-A of FIG. 4.

FIG. 6 is a schematic diagram of a collection and separation chamber in one embodiment of the present application.

FIG. 7 is a schematic diagram of the section B-B of FIG. 6.

In the drawings: 1: chain scraper conveyor; 2: motor I; 3: transmission chain I; 4: exhaust funnel; 5: parallel chain scraper conveyor; 6: oxygen supply opening and oxygen control valve; 7: collection and separation chamber; 8: flue gas inlet; 9: chain wheel ii; 10: pipeline I; 11: water pump; 12: pyrolysis and carbonization chamber; 13: transmission chain II; 14: motor II; 15: chain wheel II; 16: sealing plate; 17: bearing pedestal III; 18: shaft coupler; 19: motor III; 20: traction device; 21: front wheel; 22: screw conveyor I; 23: frame; 24: rear wheel; 25: discharging barrel; 26: chain wheel iv; 27: chain IV; 28: chain wheel IV; 29: motor IV; 30: bearing pedestal iii; 31: chain wheel I; 32: chain wheel i; 33: partition plate I; 34: sprayer I; 35: partition plate II; 36: partition plate III; 37: partition plate IV; 38: collected liquid outlet; 39: material outlet; 40: screw conveyor II; 41: sealing cover; 42: sewage draining exit; 43: thermal insulation material; 44: end cover; 45: material inlet; 46: cleaning door; 47: dust falling area; 48: collection box; 49: separation area; 50: pipeline II; 51: sprayer II; and 52: valve.

### DETAILED DESCRIPTION OF THE EMBODIMENTS

The technical solutions in embodiments of the present application are clearly and completely described below with reference to the accompanying drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

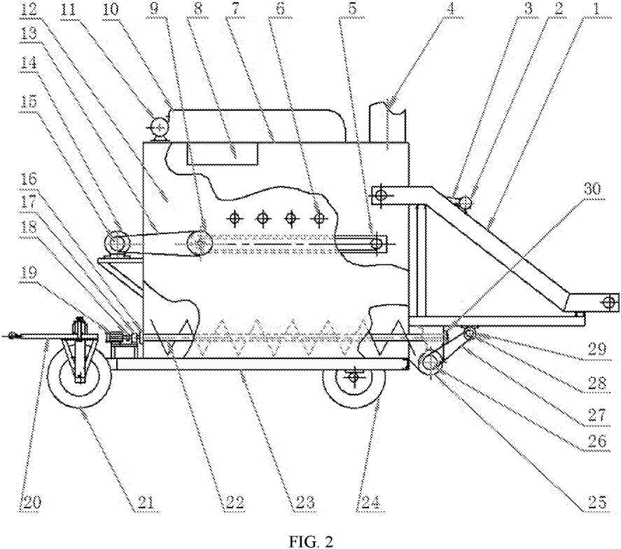

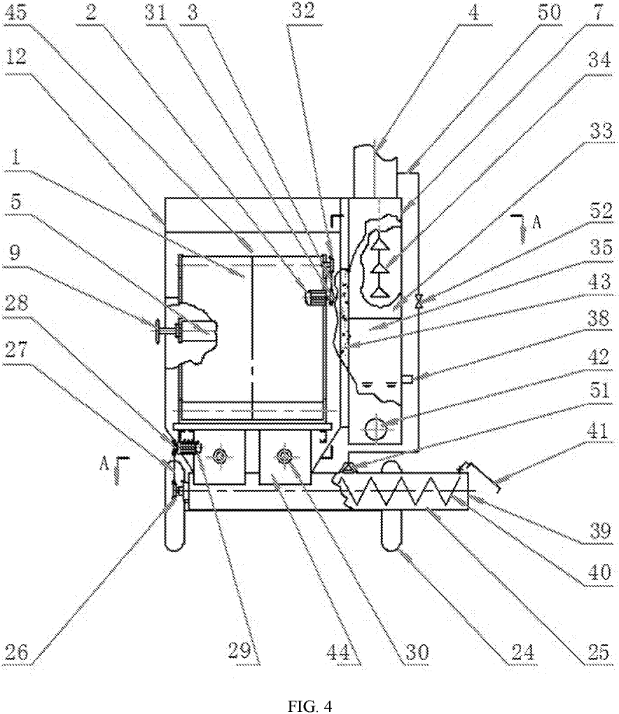

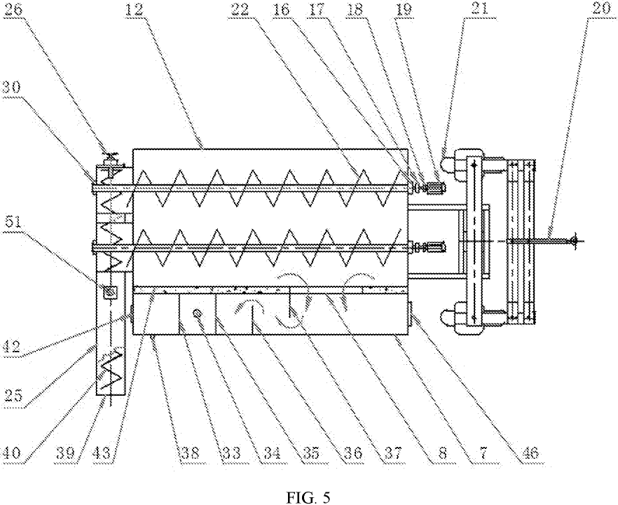

As shown in FIG. 2 to FIG. 4, in one embodiment of the present application, a device for rapidly preparing carbon from straws and recycling and treating flue gas and smoke dust includes a pyrolysis and carbonization chamber 12, and a collection and separation chamber 7;
the pyrolysis and carbonization chamber 12 and the collection and separation chamber 7 are communicated with each other through a flue gas inlet 8;
the collection and separation chamber 7 includes a separation area 49, and a sprayer I 34 is further disposed in the separation area 49; and
flue gas enters the separation area 49 through the flue gas inlet 8 and is then discharged.

According to this embodiment, the separation area 49 is used to recycle, through the sprayer I 34, gaseous biomass energy produced during the pyrolysis, and biomass energy conversion liquid is used to replace water; the gaseous biomass energy is continuously recycled and converted, and the main component-biomass energy in the flue gas is converted into straw vinegar for recycling, so that the utilization rate of biomass energy of straws of the original device is increased by 30-33% to 50%; and meanwhile, the biomass energy conversion liquid replaces water to make suspended particles produced during the pyrolysis and carbonization settle down.

In this embodiment, the pyrolysis and carbonization chamber 12 is integrally connected. Due to the above integrated design solution, the efficiency of this embodiment is greatly improved; lots of carbonization chamber materials are saved; and the operability is achieved. Similarly, due to the above integrated design solution, this embodiment puts forward higher requirements for a sealing manner: (1) a screw conveyor I 22 and a screw conveyor II 40 which are intersected by 90 degrees are disposed described below; (2) a sealing cover 41 is further arranged at an outlet of the screw conveyor II 40; and (3) the screw conveyor II 40 is further hermetically connected to a sprayer II 51 described below through a pipeline. At a pipeline outlet of the sprayer II 51, cold spraying liquid and hot straw carbon are in contact with each other, and produced gas blocks gas outside the equipment, so that the sealing cover is opened, and intact straw carbon is pushed out. More importantly, the above integrated setting manner can achieve technical effects of “isolating oxygen during carbonization and supplying oxygen during pyrolysis”.

Further, the collection and separation chamber 7 further includes a dust falling area 47. The dust falling area 47 is communicated with the separation area 7; and after entering the dust falling area 47 of the collection and separation chamber 7 through the flue gas inlet 8, the flue gas enters the separation area 49 and is then discharged.

As shown in FIG. 2 to FIG. 4, in this embodiment, the device further includes a frame 23. The pyrolysis and carbonization chamber 12 and the collection and separation chamber 7 are mounted on the frame 23. Further, a pair of front wheels 21 (for steering) is mounted at a front part of the frame 23, and a pair of rear wheels 24 is mounted at a rear part of the frame. A traction device 20 is mounted in front of the frame 23 and is connected to a towing tractor.

A thermal insulation material 43 is arranged between the pyrolysis and carbonization chamber 12 and the collection and separation chamber 7. Due to the arrangement of the thermal insulation material 43, the impact on the effect of the collection and separation chamber 7 can be avoided.

Further, in this embodiment, the pyrolysis and carbonization chamber 12 is further provided with several oxygen supply openings, and oxygen control valves are further arranged on the oxygen supply openings. The oxygen control valve is used for controlling a feeding volume of air or oxygen.

Further, in this embodiment, a conveying device used for conveying a material is mounted in the pyrolysis and carbonization chamber 12.

Optionally, the conveying device includes a parallel conveying device, and the parallel conveying device is mounted in the pyrolysis and carbonization chamber 12.

The parallel conveying device adopts a parallel chain scraper conveyor 5; the parallel chain scraper conveyor 5 includes a chain wheel ii 9, a transmission chain II 13, a motor II 14, and a chain wheel II 15; and the chain wheel ii 9 located at a front end of the parallel chain scraper conveyor 5 is connected to the chain wheel II 15 externally located at an output end of the motor II 14 through the transmission chain II 13 to achieve driving. The parallel chain scraper conveyor 5 conveys an input material from the rear part to the front part, and the input material falls to a bottom of the pyrolysis and carbonization chamber 12 after being pyrolyzed. Two parallel chain scraper conveyors 5 are used to connect material feeding with pyrolysis, and a relationship between a feeding amount and a pyrolysis time is transformed into a relationship between mechanical transmission rates, so that it is easier and more reliable to control the pyrolysis degree.

A material inlet 45 of the pyrolysis and carbonization chamber 12 is further communicated with a feeding device, and/or, a material outlet 39 of the pyrolysis and carbonization chamber 12 is further communicated with a discharging device. The feeding device is mounted at a tail part of the frame 23.

Further optionally, the feeding device adopts a chain scraper conveyor 1. The chain scraper conveyor 1 includes a motor 12, a chain wheel I 31, a transmission chain I 3, and a chain wheel i 32; the chain wheel I 31 at an output end of the motor I 2 is connected to the chain wheel i 32 at a driving end of the chain scraper conveyor 1 through the transmission chain I 3 to achieve driving; and the chain scraper conveyor 1 conveys the material into the pyrolysis and carbonization chamber 12 through the material inlet 45.

In this embodiment, the discharging device adopts a screw conveyor I 22, and an outlet of the screw conveyor I 22 is connected to a discharging barrel 25. In this embodiment, two screw conveyors I 22 are disposed side by side (to increase the discharging rate) to discharge materials together; an output shaft of a motor III 19 located at the front part of the frame 23 is connected to one end of a rotating shaft through the shaft coupler 18; one end of the rotating shaft is fixedly mounted through a bearing pedestal III 17 and penetrates into the bottom of the pyrolysis and carbonization chamber 12 through a sealing plate 16; and the other end of the rotating shaft is supported at an end cover 44 through a bearing pedestal iii 30.

Outlets of the two screw conveyors are respectively connected to the discharging barrel 25, and the screw conveyor II 40 is mounted in the discharging barrel 25; and the sealing cover 41 is mounted at a material outlet 39 of the discharging barrel 25. A chain wheel IV 28 of an output end of the motor IV 29 located at the front part of the frame 23 is connected to a chain wheel iv 26 located at an extending end of a rotating shaft of the screw conveyor II 40 through a transmission chain IV 27 to drive the screw conveyor II 40. The straw carbon is moved, fed and exported through the vertically disposed screw conveyors with different functions.

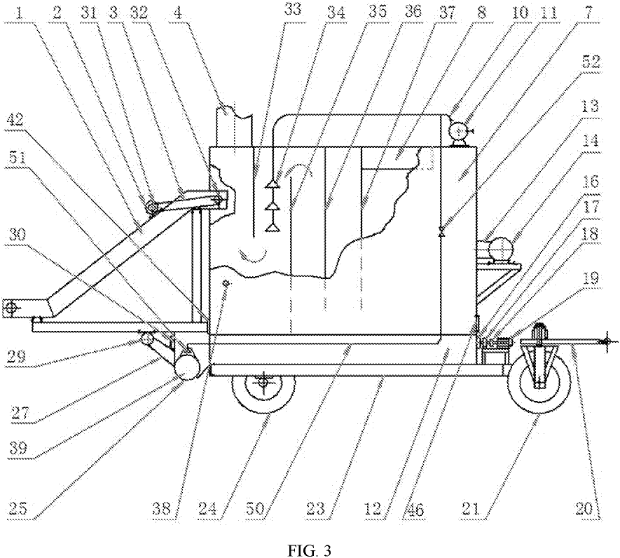

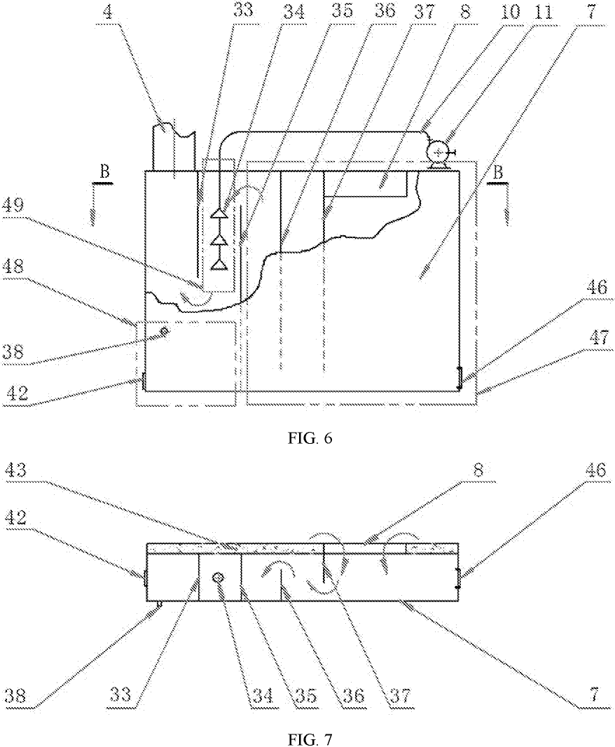

As shown in FIG. 3, the pyrolysis and carbonization chamber 12 and the collection and separation chamber 7 are communicated with each other through the flue gas inlet 8 located at the upper part. As shown in FIG. 6, after passing through the flue gas inlet 8, flue gas first enters the dust falling area 47 of the collection and separation chamber 7, then enters the separation area 49, and finally enters a flue, so as to be discharged by an exhaust funnel 4.

As shown in FIG. 7, a main body of the collection and separation chamber 7 includes the dust falling area 47, the separation area 49, the flue (the exhaust funnel 4) and a collection box 48. At least one partition plate III 36, at least one partition plate IV 37, or at least one partition plate III 36 and one partition plate IV 37 which are disposed on the left and right in a spacing manner are arranged in the dust falling area 47 for allowing the flue gas to pass. Due to the arrangement of the above partition plates, the flue gas collection efficiency can be improved, impurities in the flue gas can be reduced, and the purity of straw vinegar recycling can be increased.

In this embodiment, preferably, a labyrinth passage composed of the partition plate III 36 and the partition plate IV 37 which are transversely disposed on the left and right is formed in the dust falling area 47 for allowing the flue gas to pass, and dust falling is carried out; and a cleaning door 46 is arranged at a bottom of the dust falling area 47. The separation area 49 is a core area of this chamber. As shown in FIG. 6, the separation area 49 includes a lower partition plate, an upper partition plate, and a sprayer I 34 (including a pipeline I 10 used therewith and a water pump 11) between the two partition plates. Specifically, the separation area 49 is composed of a partition plate I 33 (used as the upper partition plate) and a partition plate II 35 (used as the lower partition plate) which are disposed at upper and lower positions. The flue gas enters the separation area 49 from above the partition plate II 35 and enters the flue (the exhaust funnel 4) from below the partition plate I 33.

The sprayer I 34 is arranged in the separation area 49 and is used for cooling the recycled straw vinegar; and the collection box 48 is arranged below the separation area 49. An upper part of the collection box 48 is provided with a collected liquid outlet 38, and a bottom of the collection box is provided with a sewage draining exit 42. The collection box 48 may be communicated with the sprayer I 34.

Further, the water pump 11 is arranged on a top surface of the collection and separation chamber 7; an outlet of the water pump 11 is respectively connected to the sprayer I 34 and the sprayer II 51 through the pipeline I 10 and a pipeline II 50; the sprayer II 51 is located in the discharging barrel 25; and the sprayer II 51 (including a valve 52 assorted therewith, a pipeline and the water pump 11) is used for performing fire extinguishing and dust removal on the straw carbon exported by the screw conveyor II 40. The sprayer II 51 may be further connected to the above collection box 48.

In this embodiment, the sprayer II 51 and the sprayer I 34 may share the same water pump 11.

Further, the sealing cover 41 is mounted at the material outlet 39 of the discharging barrel 25.

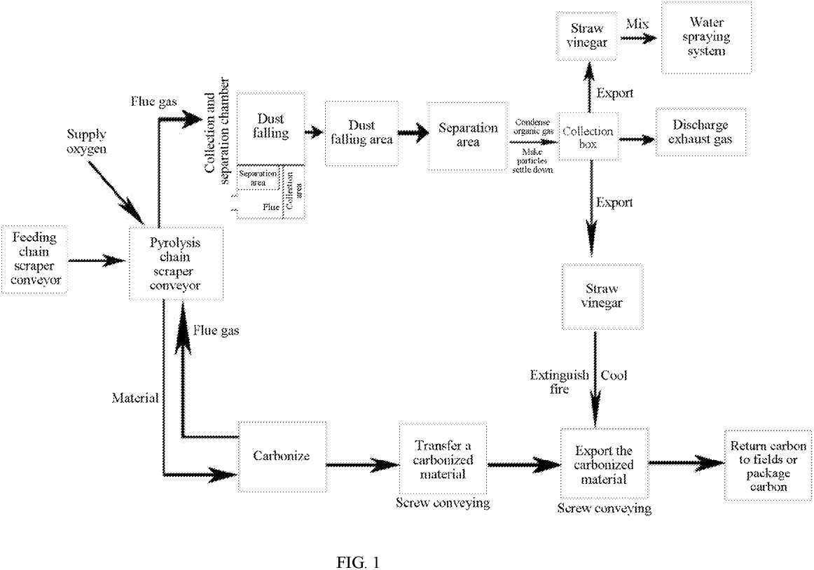

As shown in FIG. 1, in this embodiment, a method for rapidly preparing carbon from straws and recycling and treating flue gas and smoke dust is provided, the method including:
step I, straws that are ignited outside are introduced into a pyrolysis and carbonization chamber 12;
step II, flue gas produced by the pyrolysis and carbonization chamber 12 in running is introduced into a collection and separation chamber 7 via a flue gas inlet 8, and the flue gas is at least separately treated in a separation area 49 in the collection and separation chamber 7; and
step III, the flue gas is introduced into the separation area 49, and main component-biomass energy in the flue gas is converted into straw vinegar using a sprayer I 34 in the separation area.

Further, the method further includes step IV: the straw vinegar is recycled, wherein the recycled straw vinegar falls off to be collected, and the collected straw vinegar enters a spraying circulating system; and finally, the flue gas enters a flue and is discharged.

As shown in FIG. 2, in this embodiment, another method for rapidly preparing carbon from straws and recycling and treating flue gas and smoke dust is further provided, the method including:
Step I, the straws that are ignited outside are introduced into the pyrolysis and carbonization chamber 12 and fall to the upper part of the conveying device.
Step II, the straws are continuously introduced to a conveying device in the pyrolysis and carbonization chamber 12 for pyrolysis, and a pyrolyzed material is conveyed to the tail end by the conveying device and falls to a lower part in the pyrolysis and carbonization chamber 12 for carbonization,
wherein the conveying device divides the pyrolysis and carbonization chamber 12 into an upper part and a lower part with different functions: the upper part is a pyrolysis area and the lower part is a carbonization area.

Step III, flue gas and smoke dust which are produced by the pyrolysis and carbonization chamber 12 in running are introduced into a collection and separation chamber 7 via a flue gas inlet 8, and the flue gas and the smoke dust are separately treated in different areas such as the dust falling area 47, the separation area 49 and a flue in the collection and separation chamber 7.

Step IV, the flue gas enters the separation area 49; main component-biomass energy in the flue gas is converted into straw vinegar using a sprayer I 34 in the separation area 49; the recycled straw vinegar falls off to be collected, and the collected straw vinegar enters a spraying circulating system; and finally, the flue gas enters the flue and is discharged.

In the method of this embodiment, the technical solution of the device involved refers to the description above, and descriptions thereof are omitted here.

Further, in the above step I, the straws that are ignited outside are introduced into the pyrolysis and carbonization chamber 12 and fall to the upper part of the conveying device. Specifically, the straws that are ignited outside are first introduced into the pyrolysis and carbonization chamber 12 by a chain scraper conveyor 1 and fall to the upper part of a parallel chain scraper conveyor 5. In this embodiment, the conveying device is preferably a parallel conveying device, more preferably the parallel chain scraper conveyor 5.

The straws are then continuously introduced by the chain scraper conveyor 1 to the parallel chain scraper conveyor 5 in the pyrolysis and carbonization chamber 12 for pyrolysis; the volume of fed oxygen is adjusted by controlling the oxygen supply opening and oxygen control valve 6 to adjust the pyrolysis degree; and two speed-adjustable chain scraper conveyors (the chain scraper conveyor 1 and the parallel chain scraper conveyor 5) are adopted for feeding and pyrolysis, so that a manually controlled feeding volume and the pyrolysis time are transformed into a transmission rate relationship between the two chain scraper conveyors. The pyrolyzed material is conveyed by the parallel chain scraper conveyor 5 to the tail end and falls to the lower part in the pyrolysis and carbonization chamber 12 for carbonization.

The conveying device divides the pyrolysis and carbonization chamber 12 into an upper part and a lower part with different functions: the upper part is a pyrolysis area and the lower part is a carbonization area. Specifically, the parallel chain scraper conveyor 5 divides the pyrolysis and carbonization chamber 12 into the upper part and the lower part with different functions: the upper part is the pyrolysis area and the lower part is the carbonization area.

A screw conveyor I 22 located at the bottom conveys the carbonized material to a discharging barrel 25, and a screw conveyor II 40 exports the carbonized material sent by the screw conveyor I 22 after the carbonized material is subjected to cooling, fire extinguishing and dust removal by a sprayer II 51.

In the above step III, before the flue gas is introduced into the separation area 49, the method further includes: the flue gas is introduced into the dust falling area 47 of the collection and separation chamber 7; the flue gas produced by the pyrolysis and carbonization chamber 12 in running is introduced into the collection and separation chamber 7 via the flue gas inlet; and the flue gas is at least separately treated in the dust falling area and the separation area in the collection and separation chamber 7. Specifically, flue gas and smoke dust which are produced by the pyrolysis and carbonization chamber 12 in running are introduced into the collection and separation chamber 7 via the flue gas inlet 8, and the flue gas and the smoke dust are separately treated in different areas such as the dust falling area 47, the separation area 49, the collection box 48, and a flue in the collection and separation chamber 7. A dust falling effect is achieved on the smoke dust in the dust falling area 47 through a partition plate IV 37 and a partition plate III 36, and dust is discharged through a cleaning door 46. The flue gas enters the separation area 49 from above the partition plate II 35; the sprayer I 34 has functions of sealing, drafting, condensation and separation; the sealing function means that the two partition plates (the partition plate I 33 and the partition plate II 35) and the sprayer I 34 that is in a working state jointly construct a space, and the space forces hot air flow to pass through and satisfies a temperature condition for converting the pyrolyzed gaseous biomass energy into liquid (a boundary temperature value for converting gaseous biomass energy into liquid biomass energy is 80° C.); the drafting function refers to a downward jetting force of a spray atomizer; the condensation function refers to spraying liquid with a temperature of 40° C. or below; and the separation function refers to separating liquid, gas, and dust. The kinetic energy of the water pump 11 is used to create the functions of sealing, drafting, condensation and separation for the separation area 49; the main component-biomass energy in the flue gas is converted into the straw vinegar for recycling; and the utilization rate of biomass energy of straws of the original device is increased by 30-33% to 50%.

In the above step IV, the recycled straw vinegar falls into the collection box 48 below, and the collection box 48 is provided with a collected liquid outlet 38 (used as an overflow opening) and a sewage draining exit 42. The recycled straw vinegar flows out from the collected liquid outlet 38, and the outflow straw vinegar is mixed into and participates in the spraying circulating system, and is gradually transitioned to the self-circulation of straw vinegar spraying. Firstly, the self-circulation of the straw vinegar ensures the continuous running of the collection and separation chamber 7 through the sprayer I 34, so as to cyclically recycle the straw vinegar. Secondly, the straw vinegar is added into the sprayer II 51, and the straw carbon is subjected to cooling, fire extinguishing and dust falling using the straw vinegar, so that the working environment is improved, a load of carrying a water source on the mobile device is reduced and all-weather running of the equipment is guaranteed. Finally, the flue gas enters the flue through below the partition plate I 33, and is discharged through the exhaust funnel 4.

According to the present application, the separation area 49 is used to recycle, through the sprayer I 34, gaseous biomass energy produced during the pyrolysis, and biomass energy conversion liquid is used to replace water; the gaseous biomass energy is continuously recycled and converted, and the main component-biomass energy in the flue gas is converted into the straw vinegar for recycling, so that the utilization rate of biomass energy of straws of the original device is increased by 30-33% to 50%; and meanwhile, the biomass energy conversion liquid replaces water to make suspended particles produced during the pyrolysis and carbonization settle down. In the present application, two chain scraper conveyors are used to connect material feeding with pyrolysis, and a relationship between a feeding amount and a pyrolysis time is transformed into a relationship between mechanical transmission rates, so that it is easier and more reliable to control the pyrolysis degree. In addition, the two independent pyrolysis and carbonization tanks in the original device are changed into one chamber body that is divided into upper and lower parts by the chain scraper conveyor, and the two parts are closely connected to each other and have different functions. The thermal energy utilization efficiency of the present application is improved, thereby laying a foundation for the standard production of different types of straw carbon. For example, due to a controllable degree of pyrolysis, if the main purpose of straw carbon production is to return “carbon” to fields, and to pursue “carbon neutralization”, a deep carbonization process that prolongs the carbonization time is adopted. On the contrary, if the main purpose is to kill insect eggs and pathogenic bacteria, and to return more original organic matters to fields, a light carbonization process with short carbonization time (only several minutes) is adopted. To sum up, the present application has a good market application prospect.

In the description of the present application, unless otherwise explicitly specified or defined, the terms such as “connect”, “connection”, and “fixed” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components or mutual interaction relationship between two components. A person of ordinary skill in the art may understand the specific meanings of the foregoing terms in the present application according to specific situations.

In the present application, unless otherwise clearly stipulated and limited, that a first feature is “above” or “below” a second feature may include that the first feature directly contacts the second feature, or may include that the first feature does not contact the second feature directly but contacts the second feature by means of another feature between them. Moreover, the first feature being “over”, “above”, and “on” the second feature includes that the first feature is directly above or obliquely above the second feature, or only means that a horizontal height of the first feature is higher than that of the second feature. That the first feature is “below”, “under”, and “underneath” the second feature includes that the first feature is directly below or obliquely below the second feature, or only means that a horizontal height of the first feature is lower than that of the second feature.

In the description of this embodiment, orientation or position relationships indicated by the terms such as “upper”, “lower”, “left”, and “right” are based on orientation or position relationships shown in the accompanying drawings, and are used only for ease and brevity of illustration and operation, rather than indicating or implying that the mentioned apparatus or component needs to have a particular orientation or needs to be constructed and operated in a particular orientation. Therefore, such terms should not be construed as limiting of the present application. In addition, the terms “first” and “second” are only used for distinction in description, and have no special meaning.

The foregoing specific embodiments are merely intended for describing the technical solutions of the present application but not for limiting the present application. Although the present application is described in detail with reference to the exemplary embodiments, a person of ordinary skill in the art should understand that they may still make modifications or equivalent replacements to the technical solutions described in the present application without departing from the spirit and scope of the technical solutions of the embodiments of the present application, which should all be covered in the claims of the present application.

What is claimed is:

1. A device for rapidly preparing carbon from straws and recycling and treating flue gas and smoke dust, comprising a pyrolysis and carbonization chamber, and a collection and separation chamber, wherein
the pyrolysis and carbonization chamber and the collection and separation chamber are communicated with each other through a flue gas inlet;
the collection and separation chamber comprises a separation area, wherein a first sprayer is disposed in the separation area; and
the flue gas enters the separation area through the flue gas inlet and is then discharged.

2. The device according to claim 1, wherein the collection and separation chamber further comprises a dust falling area, wherein the dust falling area is communicated with the separation area; and after entering the dust falling area of the collection and separation chamber through the flue gas inlet, the flue gas enters the separation area and is then discharged.

3. The device according to claim 1, wherein a water pump is arranged on the collection and separation chamber, and an outlet of the water pump is connected to the first sprayer through a pipeline.

4. The device according to claim 1, wherein the separation area comprises a first partition plate and a second partition plate, wherein the first partition plate and the second partition plate are disposed at upper and lower positions; the flue gas enters the separation area from above the second partition plate; and the flue gas enters an exhaust funnel from below the first partition plate.

5. The device according to claim 1, wherein a collection box is arranged below the separation area.

6. The device according to claim 5, wherein the collection box is communicated with the first sprayer; and/or, a water pump is connected between the collection box and the first sprayer.

7. The device according to claim 5, wherein an upper part of the collection box is provided with a collected liquid outlet, and a bottom of the collection box is provided with a sewage draining exit.

8. The device according to claim 2, wherein a bottom of the dust falling area is provided with a cleaning door.

9. The device according to claim 2, wherein at least one third partition plate is arranged in the dust falling area for allowing the flue gas to pass, or at least one fourth partition plate is arranged in the dust falling area for allowing the flue gas to pass, or at least one third partition plate and at least one fourth partition plate which are disposed on left and right in a spacing manner are arranged in the dust falling area for allowing the flue gas to pass;
wherein a flue gas collection efficiency is improved; impurities in the flue gas are reduced; and a purity of straw vinegar is increased.

10. The device according to claim 1, wherein a thermal insulation material is arranged between the pyrolysis and carbonization chamber and the collection and separation chamber.

11. The device according to claim 1, wherein a conveying device configured for conveying a material is mounted in the pyrolysis and carbonization chamber.

12. The device according to claim 11, wherein the conveying device comprises a parallel conveying device, and the parallel conveying device adopts a parallel chain scraper conveyor.

13. The device according to claim 1, wherein a material inlet of the pyrolysis and carbonization chamber is communicated with a feeding device, and/or, a material outlet of the pyrolysis and carbonization chamber is communicated with a discharging device.

14. The device according to claim 13, wherein the feeding device adopts a chain scraper conveyor; and/or, the discharging device adopts a first screw conveyor, wherein an outlet of the first screw conveyor is connected to a discharging barrel.

15. The device according to claim 13, further comprising a discharging barrel, wherein the discharging barrel is arranged at an outlet of the discharging device; and a second screw conveyor is mounted in the discharging barrel.

16. The device according to claim 15, wherein a second sprayer is mounted in the discharging barrel, and/or, the second sprayer is further connected to a collection box.

17. The device according to claim 1, wherein the pyrolysis and carbonization chamber is integrally formed; and/or, the pyrolysis and carbonization chamber is further provided with an oxygen supply opening and an oxygen control valve.

18. A method for rapidly preparing carbon from straws and recycling and treating flue gas and smoke dust, comprising:
introducing the straws into a pyrolysis and carbonization chamber, wherein the straws are ignited outside;
introducing the flue gas produced by the pyrolysis and carbonization chamber in running into a collection and separation chamber via a flue gas inlet, and at least separately treating the flue gas in a separation area in the collection and separation chamber; and
introducing the flue gas into the separation area, and converting main component-biomass energy in the flue gas into straw vinegar using a sprayer in the separation area.

19. The method according to claim 18, further comprising: recycling the straw vinegar, wherein the recycled straw vinegar falls off to be collected, and the collected straw vinegar enters a spraying circulating system; and finally, the flue gas enters a flue and is discharged.

20. The method according to claim 18, further comprising: before introducing the flue gas into the separation area, introducing the flue gas into a dust falling area of the collection and separation chamber, introducing the flue gas produced by the pyrolysis and carbonization chamber in running into the collection and separation chamber via the flue gas inlet, and at least separately treating the flue gas in the dust falling area and the separation area in the collection and separation chamber.
